(19) United States
(12) Patent Application Publication
(10) Pub. No.: US 2017/0326571 A1
(43) Pub. Date: Nov. 16, 2017

(54) FLEXIBLE BURSH AXIS GUARD

(71) Applicant: TD Industrial Coverings, Inc., Sterling Heights, MI (US)

(72) Inventor: Mark D'Andreta, Ortonville, MI (US)

(21) Appl. No.: 15/185,086

(22) Filed: Jun. 17, 2016

Related U.S. Application Data
(60) Provisional application No. 62/336,807, filed on May 16, 2016.

(51) Int. Cl. B05B 13/02; B05C 1/06; B25J 19/00

(52) U.S. Cl. CPC B05B 13/02; B25J 19/0075; B05C 1/06; Y10S 901/49; Y10S 901/43

(57) ABSTRACT

An arrangement for automated painting of an object includes a paint robot, a cover and a cover blocking member. The paint robot defines an axis joint about which a first portion rotates relative to a second portion. The cover covers at least a portion of the paint robot. The cover blocking member is in the form of a strip brush including a plurality of bristles. The strip brush is carried by the paint robot and is positioned between the paint robot and the cover.

### FIELD

The present disclosure relates to the automated painting of motor vehicles and the like with paint robots. The present disclosure more particularly relates to an apparatus for preventing a cover for a paint robot from being drawn into an axis joint of the paint robot. The present disclosure also relates to a method for preventing a cover for a paint robot from being drawn into an axis joint of a paint robot.

### BACKGROUND

This section provides background information related to the present disclosure which is not necessarily prior art.

Painted goods such as automobiles and the like conventionally utilize a dedicated paint area or paint room for the application of paint. The paint rooms are highly regulated to promote a quality paint finish. For example, most conventional clothing is prohibited due to the loose fibers which otherwise end up in the paint. Additionally, various lotions and other personal products are prohibited due to their adverse effect on the painting process.

In many applications, paint is applied to articles such as automobiles with automated paint robots. The robots advantageously eliminate human error, reduce labor and provide improved and repeatable quality. The application of paint with automated paint robots is necessarily associated with a degree of overspray. Some overspray of paint is required to ensure complete painting of the subject article.

It has heretofore been appreciated in the pertinent art that automated paint robots can be equipped with covers to both protect the robot and reduce paint defects. In this regard, the covers substantially shield the robots from paint overspray, thereby protecting the moving parts. Additionally, the covers prevent the accumulation of paint that may otherwise result in the dripping of paint on the subject article. The covers can be periodically discarded and replaced.

Ongoing objectives in the pertinent art include improved cover fit to facilitate freedom of robot movement. It is also an ongoing objective to reduce any interference between the cover and the operation of the paint robot.

### SUMMARY

This section provides a general summary of the disclosure, and is not a comprehensive disclosure of its full scope or all of its features.

In accordance with one particular aspect, the present teachings provide an apparatus for preventing a cover from being drawn into an axis joint of a paint robot. The paint robot includes first and second portions rotatable relative to one another about the axis joint. The apparatus includes a strip brush including a plurality of bristles, the strip brush for at least partially extending circumferentially around one of the first and second portions of the paint robot. The apparatus further includes a mounting arrangement for fixedly securing the strip brush to one of the first or second portions of the paint robot.

In accordance with another particular aspect, the present teachings provide an arrangement for automated painting of an object. The arrangement includes a paint robot, a cover and a cover blocking member. The paint robot defines an axis joint about which a first portion rotates relative to a second portion. The cover covers at least a portion of the paint robot. The cover blocking member is carried by the paint robot, positioned between the paint robot and the cover, and includes a plurality of bristles.

In accordance with yet another particular aspect, the present teachings provide a method for preventing a cover from being drawn into an axis joint of a paint robot. The paint robot includes first and second portions rotatable relative to one another about an axis joint. The method includes providing a cover blocking member including a plurality of bristles. The method additionally includes applying the cover blocking member about one of the first and second portions of the paint robot and securing the cover blocking member to the one of the first or second portions proximate the axis joint. The method further includes rotating the first and second portions relative to each other with the cover blocking member disposed between the cover and the axis joint.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an environmental view of an apparatus according to the present teachings for preventing a cover from being drawn into an axis joint of the paint robot, the apparatus shown in dashed lines operatively associated with an exemplary paint robot and cover.

FIG. 2 is a perspective view of the apparatus for preventing a cover from being drawn into an axis joint of a paint robot of the present teachings, the apparatus shown operatively associated with an exemplary paint robot, the cover of FIG. 1 shown removed for purposes of illustration.

FIG. 3 is another perspective view of the apparatus for preventing a cover from being drawn into an axis joint of a paint robot of the present teachings shown operatively associated with an exemplary paint robot.

Corresponding reference numerals indicate corresponding parts throughout the several views of the drawings.

### DETAILED DESCRIPTION

Example embodiments will now be described more fully with reference to the accompanying drawings.

An example embodiment is provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

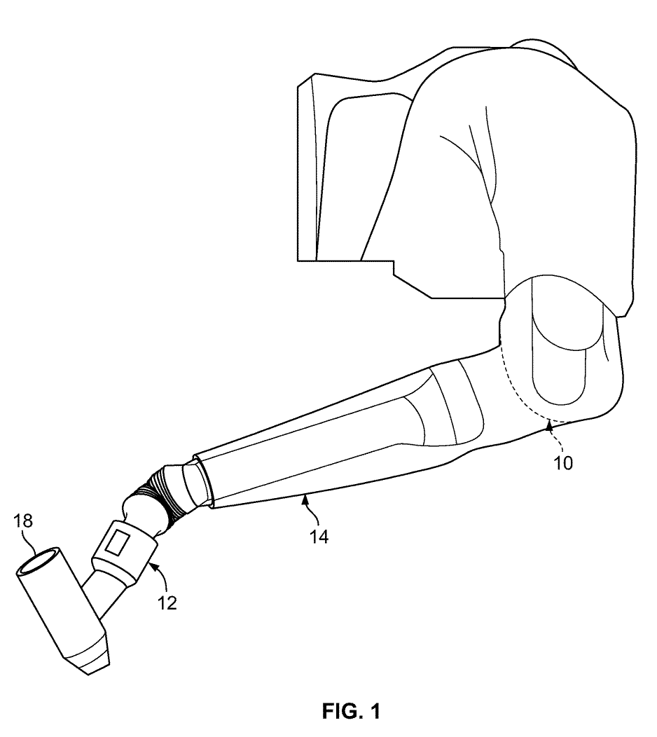

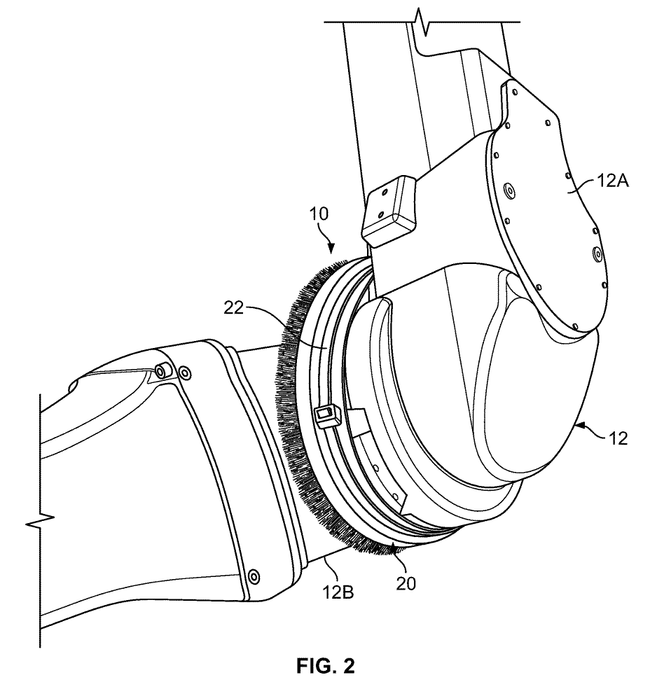

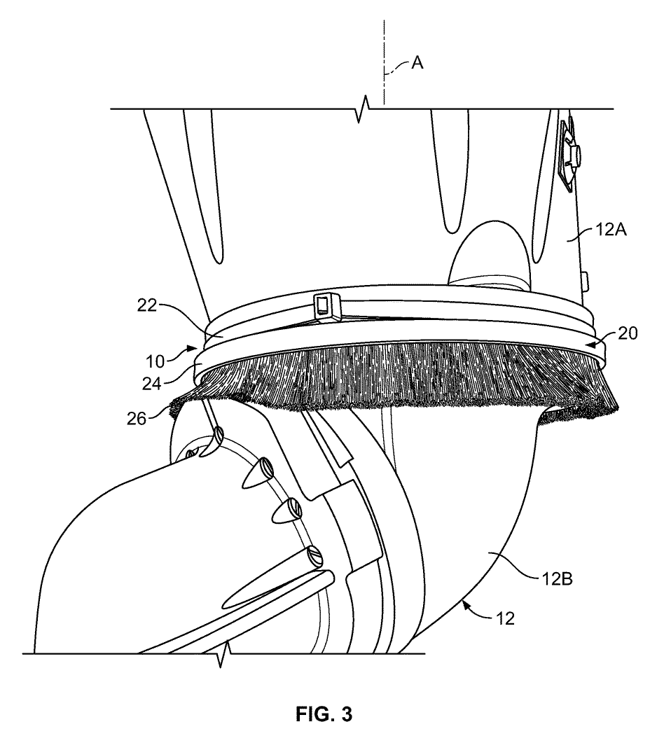

With general reference to the drawings, an apparatus according to the present teachings for preventing the cover from being drawn into an axis joint of a robot is illustrated and generally identified at reference character 10. FIGS. 1-3 illustrate the apparatus 10 operatively attached to a paint robot 12. FIG. 1 illustrates the robot 12 covered with a paint cover 14, the apparatus 10 of the present teachings positioned between the cover 14 and the robot 12 to prevent the cover 14 from being drawn into an axis joint of the robot 12. It will be understood that the axis joint being protected is covered by the blocking member 20. As such, the axis joint is concealed in the drawings by the blocking member 20.

It will be understood that the robot 12 and paint cover 14 shown in the drawings are conventional in both construction and operation in so far as the present teachings are concerned and to any extent not otherwise described herein. It will be further understood that the present teachings may be adapted for use with various robots and covers.

The robot 12 conventionally functions to deliver a source of paint to an object such as a motor vehicle or the like. The robot 12 may be computer controlled to articulate as necessary for automated painting of the object. A distal end of the paint robot 12 may carry a paint gun 18.

The paint robot 12 is capable of various movements for desired positioning of the paint gun 18 relative to the object to be painted. Relevant to the apparatus of the present teachings, the paint robot 12 includes first and second portions 12A and 12B rotatable relative to one another. The first and second portions 12A and 12B rotate relative to one another at the axis joint 16 about a rotation axis A of the axis joint 16.

The paint cover 14 covers at least a portion of the robot 12. As particularly illustrated in FIG. 1, the cover 14 substantially covers the robot 12 and protects the robot 12 from paint overspray. In the relevant art, it is important that the paint cover 14 shield the robot 12 from overspray without interfering with the various required movements of the robot 12. Generally speaking, a relatively snug fit of the cover 14 is desired to accomplish these objectives and to avoid material (i.e., paint) waste. The paint cover 14 may be removed and replaced after it becomes saturated with paint or becomes worn. Various paint covers are known in the relevant art, including but not limited to the paint covers shown and described in commonly owned U.S. Publication Nos. 2006/0141200; 2004/0258877; and U.S. Design Pat. D496,952; and 491,964, for example. U.S. Publication Nos. 2006/0141200; 2004/0258877; and U.S. Design Pat. D496,952; and 491,964 are incorporated by reference as if fully set forth herein.

The apparatus 10 of the present teachings is generally illustrated to include a blocking member 20 and a mounting arrangement 22. The blocking member 20 may be a brush such as a strip brush having a base 24 and a plurality of bristles 26 generally circular ring or a band. In the embodiment illustrated, the blocking member 20 may define a complete circle.

In one particular application, the base 24 of the brush 18 may be constructed from a generally flat stock material. As shown in the drawings, the stock material may be a flexible plastic and may have a length of about 48 inches and a width of about 1.5 inches, for example. It will be understood, however, that the dimensions may be varied within the scope of the present teachings. In this regard, the length is significantly greater than the width. The circular shape of the blocking member 20 may be configured by bending the flat stock material of the base 24. It will be appreciated by those skilled in the art that other materials may be readily employed and further that the identified dimensions may be readily changed for other applications. It will also be understood that the base 24 may be formed of one or more parts.

The flat stock material of the base 24 of the blocking member 20 may be wrapped about one of the first and second portions 12A and 12B of the paint robot 12 at the painting site. Thereafter, the blocking member 20 may be fixedly secured to the one of the first and second portions 12A and 12B of the paint robot 12. As illustrated, the blocking member 20 may be concentrically positioned relative to the one of the first and second portions 12A and 12B and spaced therefrom. In the embodiment illustrated, the blocking member 20 is secured to the first or proximal portion 12A of the paint robot 12. As shown in the environmental view of FIG. 1, the blocking member 20 is disposed between the robot 12 and the paint cover 14 and circumferentially surrounds the rotation axis A of the axis joint 16. The plurality of bristles 26 may extend generally parallel to the rotation axis 12. As illustrated, the plurality of bristles 26 may extend toward the painting end or distal end of the robot 12.

The apparatus 10 of the present teachings may be secured to the robot 12 in any manner well known in the art. As shown, the mounting arrangement 22 for securing the blocking member 20 to the robot 12 may include a zip tie. Alternatively, the base 22 of the brush 18 may be secured to the robot with fasteners.

The blocking member 20 may be carried by the first portion 12A of the robot 12 proximate the axis joint 16. In this regard, the blocking member 20 is axially positioned close to the second portion 12B of the robot 12 but slightly spaced from the second portion 12B so as to not interfere with relative rotation therebetween.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An apparatus for preventing a cover from being drawn into an axis joint of a paint robot, the paint robot including first and second portions rotatable relative to one another about the axis joint, the apparatus comprising:
a brush including a plurality of bristles, the brush for at least partially extending circumferentially around one of the first and second portions of the paint robot; and
a mounting arrangement for fixedly securing the brush to the one of the first and second portions of the paint robot proximate the axis joint.

2. The apparatus for preventing a cover from being drawn into an axis joint of a paint robot of claim 1, wherein the brush defines a complete circle.

3. The apparatus for preventing a cover from being drawn into an axis joint of a paint robot of claim 1, wherein the brush includes a base constructed of a flat material wrapped in a circular shape.

4. The apparatus for preventing a cover from being drawn into an axis joint of a paint robot of claim 1, in combination with the robot, the brush circumferentially extending around the one of the first and second portions of the paint robot.

5. The apparatus for preventing a cover from being drawn into an axis joint of a paint robot of claim 1, wherein the plurality of bristles extend generally parallel a rotation axis of the axis joint.

6. The apparatus for preventing a cover from being drawn into an axis joint of a paint robot of claim 1, wherein the plurality of bristles extend toward or away from a painting end of the paint robot.

7. An arrangement for automated painting of an object, the arrangement comprising:
a paint robot for applying a paint to the object, the paint robot defining an axis joint about which a first portion rotates relative to a second portion;
a cover covering at least a portion of the paint robot; and
a cover blocking member carried by the paint robot and positioned between the paint robot and the cover, the cover blocking member including a plurality of bristles.

8. The arrangement for automated painting of an object of claim 7, wherein the cover blocking member is operative to prevent the cover from being drawn into the axis.

9. The arrangement for automated painting of an object of claim 7, wherein the cover blocking member at least partially surrounds one of the first and second portions of the paint robot in a circumferential direction proximate the axis joint where the cover is likely to be drawn in.

10. The arrangement for automated painting of an object of claim 7, wherein the cover blocking member is fixedly secured to one of the first and second portions of the paint robot and concentrically oriented to a generally circular portion thereof.

11. The arrangement for automated painting of an object of claim 7, wherein the cover blocking member is selected from a circular ring and a semi-circular ring.

12. The arrangement for automated painting of an object of claim 7, wherein the plurality of bristles extend generally parallel to a rotation axis of the axis joint.

13. The arrangement for automated painting of an object of claim 7, wherein the plurality of bristles extend toward or away from a painting end of the paint robot.

14. A method for preventing a cover from being drawn into an axis joint of a paint robot, the paint robot including first and second portions rotatable relative to one another about an axis joint, the method comprising:
providing a cover blocking member including a plurality of bristles;
wrapping the cover blocking member about one of the first and second portions of the paint robot;
securing the cover blocking member to the one of the first and second portions proximate the axis joint; and
rotating the first and second portions relative to each other with the cover blocking member disposed between the cover and the axis joint.

15. The method for preventing a cover from being drawn into an axis joint of a paint robot of claim 14, wherein the cover blocking member is concentrically oriented relative to the one of the first and second portions of the paint robot.

16. The method for preventing a cover from being drawn into an axis joint of a paint robot of claim 14, wherein the plurality of bristles of the cover blocking member extends generally parallel to a rotation axis of the axis joint.

17. The arrangement for automated painting of an object of claim 16, wherein the plurality of bristles extend toward or away from a painting end of the paint robot.
